(19) United States
(12) Patent Application Publication
(10) Pub. No.: US 2009/0254633 A1
(43) Pub. Date: Oct. 8, 2009

(54) Methods, systems, and computer program products for distributing profile-based advertisement content and user identification-tagged media content

(76) Inventor: Bentley J. Olive, Apex, NC (US)

Correspondence Address: Bentley J. Olive, 453 Black Willow Drive, Apex, NC, 27523, US

(21) Appl. No.: 12/080,542

(22) Filed: Apr. 3, 2008

(51) Int. Cl. G06F 15/16

(52) U.S. Cl. 709/218

(57) ABSTRACT

Methods, systems, and computer program products for distributing profile-based advertisement content and user identification-tagged media content are disclosed. According to one aspect, a method of distributing media content and profile-based advertisement content to a user device includes receiving, from a first user device, media content identifier, an address associated with a second user device, and profile information associated with a user of the second user device. The method also include determining advertisement content associated with the profile information. Further, the identified media content and the advertisement content can be addressed using the address. The addressed media content and the advertisement content can be communicated to a network for distribution to the second user device.

### TECHNICAL FIELD

The subject matter disclosed herein relates generally to distributing media and advertisement content. More particularly, the subject matter disclosed herein relates to distributing profile-based advertisement content and user identification-tagged media content.

### BACKGROUND ART

The development of electronic devices for copying and distributing media content, particularly media content in digital format, has facilitated the sharing and distribution of media content. Particularly, the Internet has recently become a popular medium through which people can distribute media content such as music files, movies, and the like. For example, media content is popularly to electronic user devices such as computers, personal digital assistants, smart phones, and the like.

Some forms of distributing or sharing are disfavored in view of copyright laws. In particular, with the legal attack and dissolution of free peer-to-peer music sharing services, people desiring to download and share music and other content for their personal use must pay for downloads over a fee-based service. This has the drawback that it costs the consumer money. It would be desirable for users to be able to distribute or share media content freely or at least partially share the costs with another entity.

Accordingly, a need exists for improved methods and systems for sharing media content. Particularly, it is desirable to provide methods and systems for shifting the cost of access to media content from consumers to another entity.

### SUMMARY

In accordance with this disclosure, novel methods, systems, and computer program products for distributing profile-based advertisement content and user identification-tagged media content are provided.

It is an object of the present disclosure therefore to provide novel methods, systems, and computer program products for distributing profile-based advertisement content and user identification-tagged media content. This and other objects as may become apparent from the present disclosure are achieved, at least in whole or in part, by the subject matter described herein.

### BRIEF DESCRIPTION OF THE DRAWINGS

Exemplary embodiments of the subject matter will now be explained with reference to the accompanying drawings, of which:

FIG. 1 is a block diagram of a network system operable to distribute media content and profile-based advertisement content to one or more user devices in accordance with an embodiment of the subject matter disclosed herein;

FIG. 2 is a flow chart of an exemplary process for distributing media content and profile-based advertisement content to a user device in accordance with an embodiment of the subject matter disclosed herein;

FIGS. 3A and 3B are a flow chart of an exemplary process of distributing media content and profile-based advertisement content to a user device by request of a website user in accordance with an embodiment of the subject matter described herein;

FIG. 4 is a block diagram of a wireless local area network (WLAN) operable to distribute media content and profile-based advertisement content to one or more user devices in accordance with an embodiment of the subject matter disclosed herein;

FIG. 5 is a block diagram of a multi-user media content presentation system operable to present media content and advertisement content to a plurality of users in accordance with an embodiment of the subject matter described herein;

FIG. 6 is a flow chart of an exemplary process for distributing profile-based advertisement content associated with media content according to an embodiment of the subject matter described herein;

FIGS. 7A and 7B are a flow chart of an exemplary process of a web server providing a website with one or more media content for download by user devices in accordance with an embodiment of the subject matter described herein;

FIG. 8 is a flow chart of an exemplary process for distributing user identification-tagged media content according to an embodiment of the subject matter described herein;

FIG. 9 is a block diagram of a network system operable to distribute media content and a plurality of advertisement content to a user device for filtering of the advertisement content at the user device based on profile information according to an embodiment of the subject matter described herein; and

FIG. 10 is a flow chart of an exemplary process for negotiating and contracting between a media content provider and an advertiser for distributing media and advertisement content in accordance with the subject matter described herein.

### DETAILED DESCRIPTION

The subject matter described herein provides methods, systems, and computer program products for distributing profile-based advertisement content and user identification-tagged media content. In a method of distributing media content and profile-based advertisement content to a user device in accordance with the subject matter described herein, a media content identifier, an address associated with a user device intended for receipt of the identified media content, and profile information associated with a user of the user device can be received from another user device. Advertisement content associated with the profile information can be determined. Further, the identified media content and the advertisement content can be addressed using the received address. The addressed media content and the advertisement content can be communicated to a network for distribution to the user device intended for receipt of the identified media content.

The methods described herein can provide an application in the case of a user desiring to distribute media content with another user. The user desiring to distribute the media content can do so by using a user device to communicate to a server: (1) a media content identifier for the media content; (2) an address associated with a user device of the desired recipient of the media content; and (3) profile information associated with the desired recipient of the media content. The profile information of the intended recipient can be very valuable to an advertiser, particularly for targeting advertisement content to the intended recipient. Thus, by providing the profile information, an advertiser may be willing to pay all or a portion of the costs of the media content.

An advertiser can have previously negotiated with a media content provider operating the server to pay for the cost of the media content to users matching certain profiles. Thus, if the intended recipient matches the profile, advertisement content from the advertiser can be provided to the intended recipient along with the media content. As a result, the user can distribute the media content with the intended recipient by identifying the media content and providing the profile information of the intended recipient and an address associated with a user device of the intended recipient. Further, as a result, the media content provider can be compensated by the advertiser for distribution of the media content to the intended recipient. The advertiser can be provided with a way for distributing targeted advertisements to the intended recipient.

As referred to herein, “media content” refers to any type of media that can be presented to a user by a user device. Examples include music, games, audio/visual content, ring tones, screen displays, graphics, and the like. Media content can be in an electronic format and suitable for presentation to a user by use of a user device. Various other examples of media content are described herein.

As referred to herein, “media content identifier” refers to any suitable type of identifier for identifying media content. A media content identifier can be in electronic form. Media content identifier can include any suitable type of information for identifying specific media content that is desired to be provided to another user. For example, media content identifier can include the title of a song or movie, the artists associated with a song or movie, a date associated with specific media content, or a producer of specific media content.

As referred to herein, “advertisement content” refers to any type of advertisement that can be presented to a user by a user device. Examples of advertisement content can include text, graphical windows, audio, and the like. Various other examples of advertisement content are described herein.

As referred to herein, “profile information” refers to information or data that can identify a profile of a person or a user of a user device. Profile information associated with a user can include any information associated with a user that an advertiser may be interested in for targeting advertisements to a user. For example profile information can include name, age, gender, occupation, address, ethnicity, income, and the like. In one example of entering profile information, the user of a user device may enter the profile information into one or more text box menus displayed on a web page, or otherwise suitably enter the profile information to associate the profile information with media content identifier. In another example of entering profile information, the user may have previously-selected one or more other users with which to share media content and provided profile information for the other user(s). In this example, the user may select profile information by suitably specifying a previously-selected user by use of a drop down menu or a name of the other user. By identifying the previously-selected user in this way, the previously-provided profile information for the identified user can be automatically entered. Profile information may include information for determining a social network identifier for a user. Regarding social networks, the social network associated with the user can be accessed and additional profile information of the user can be accessed using the social network identifier.

As referred to herein, “an address associated with a user device” can be any address that can be used for addressing content to a user device. For example, an address can be an electronic identifier of a user device for use in distributing content to the user device. For example, an address can include an email address, an IP address, an account ID, a telephone number, or a user name or other suitable identifier usable by a server for communicating media content to a user device. Further, for example, an address may be an MSISDN or any other suitable address to identify a mobile user device for purposes of communication. In one example of entering an address, the user of a user device may enter the address into a text box menu displayed on a web page, or otherwise suitably enter the address to associate the address with media content identifier. In another example of entering an address, the user may have previously-selected one or more other users with which to share media content and provided address(es) for the other user(s). In this example, the user may select an address by suitably specifying a previously-selected user by use of a drop down menu or a name of the other user. By identifying the previously-selected user in this way, the previously-provided address for the identified user can be automatically entered.

As used herein, “a user device” refers to a device operable to present content to a user. A user device can be operable to present media content to a user. Examples of a user device include a computer, a smart phone, a PDA, a mobile phone, a portable device, an entertainment system, and a video gaming system. A user device may be any device capable of communicating data to other devices or components via a network, such as the Internet, a mobile phone network, a local area network (LAN), a wide area network (WAN), and a WAP.

The subject matter described herein may be implemented using a computer program product comprising computer executable instructions embodied in a computer-readable medium. Exemplary computer-readable media suitable for implementing the subject matter described herein include chip memory devices, disk memory devices, programmable logic devices, application specific integrated circuits, and downloadable electrical signals. In addition, a computer-readable medium that implements the subject matter described herein may be located on a single device or computing platform or may be distributed across multiple devices or computing platforms.

### Distribution of Media Content and Profile-Based Advertisement Content to a User Device

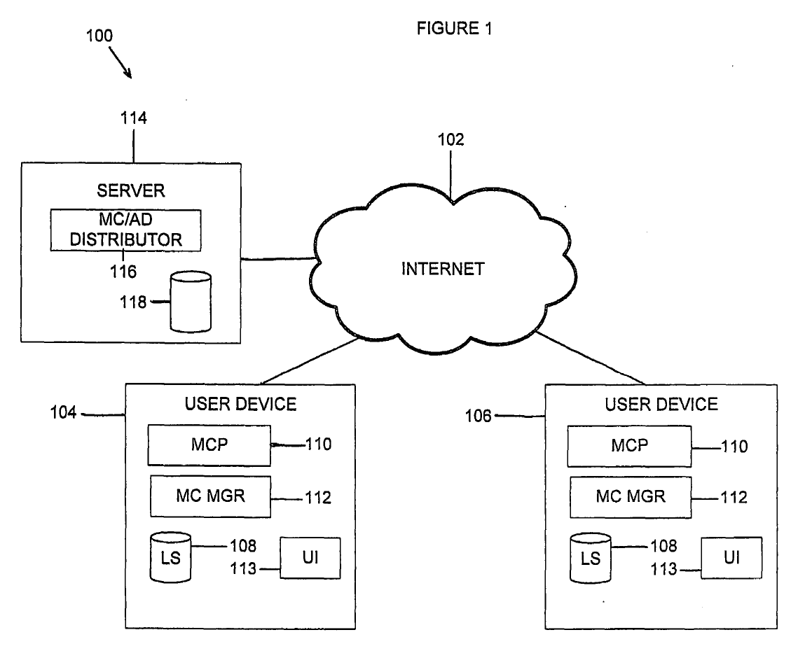

FIG. 1 is a block diagram of a network system, generally designated 100, operable to distribute media content and profile-based advertisement content to one or more user devices in accordance with an embodiment of the subject matter disclosed herein. Referring to FIG. 1, network system 100 includes a network infrastructure such as the Internet 102. The network infrastructure can include transmission paths and network devices for transmitting, routing, and receiving network data such as packets. For example, the network data can include messages, communicated between servers and user devices, that contain media content, profile information, identifiers, and/or advertisement information. Although the network shown in this example is the Internet, in the alternative, the network may be any suitable network capable of communicating data among its components.

Network system 100 can include a plurality of user devices 104 and 106 operable to access Internet 102. Although not shown here for the purpose of clarity of illustration, network system 100 can include other components, such as other devices, servers, and network devices. User devices 104 and 106 can include local storage 108 to hold media content. Further, user devices 104 and 106 can include a media content presenter 110 operable to present media content to a user.

A user of a user device can interface with the user device to implement the presentation of media content. User devices 104 and 106 can include a media content manager 112 configured to receive media content from another device or network, configured to store and access media content in local storage 108, and configured to initiate distribution of media content and profile-based advertisement content in accordance with the subject matter described herein. User devices 104 and 106 can be coupled to the Internet 102 in any suitable manner, such as by a wireless or wired connection. User devices 104 and 106 can include a user interface 113 having, for example, a display, a keyboard, a mouse, a touchscreen, speakers, and/or other suitable components for interfacing with an electronic device.

Further, network system 100 can include a server 114 operable to distribute media content and profile-based advertisement content to user devices in accordance with the subject matter disclosed herein. Server 114 can include a single or multiprocessor computer or server farm that is configured to receive and process data from the Internet 102. Server 114 can also control one or more other servers to distribute all or a portion of the media content and/or advertisement content to user devices.

Server 114 can be operated by a media content provider. The media content provider can have a business relationship with one or more advertisers to provide advertisement content along with media content to users of user devices matching particular profiles. The business relationship can be negotiated between the media content provider and the advertisers. For example, a media content provider and an advertiser can agree or contract that the advertiser pays a fee to the media content provider for each time media content is distributed to a user device of a user matching a particular profile.

In this example, the advertiser compensates the media content provider for distribution of the media content in exchange for also distributing targeted advertisement content to the user based on the user's profile. In another example, a media content provider and an advertiser can agree that the advertiser will pay a fee to the media content provider for distribution of the media content in exchange for also distributing advertisement content specified by the advertiser for distribution along with the particular media content. In this example, the advertiser compensates the media content provider for distribution of the media content in exchange for also distributing advertisement content to the user based on particular identified media content. In this way, the advertiser can pay a certain fee for particular media content that may have a high or limited number of times that a user presents the media content on the user device. Thus, media content with higher expected numbers of presentation may obtain a higher fee and conversely media content with lower expected numbers of presentation may get a lower fee.

Server 114 includes a media content/advertisement content distributor 116 configured to receive, from a first user device, a media content identifier, an address associated with a second user device, and profile information associated with a user of the second user device. The media content identifier, the address, and profile information can be received from a user device in one or more messages communicated over the Internet 102. Further, distributor 116 is configured to determine advertisement content associated with the profile information, and configured to address to the second user device media content identified by the identifier, and the advertisement content by using the address. Distributor 116 is also configured to communicate the addressed media content and advertisement content to the Internet 102 for distribution of the media content and the advertisement content to the second user device. Distributor 116 can be operable with one or more input/output modules for receipt of data from the Internet 102 and for distribution of data to user devices via the Internet 102.

Server 114 can include memory 118 for storing media content, addresses associated with user devices, profile information, and/or advertisement content. Memory 118 can represent one or more memory components residing on server 114. Alternatively, server 114 can have access to one or more other memory components that are remote from server 114 that can store media content, user device addresses, profile information, and/or advertisement content. The data can be arranged in memory such that received data is associated with each other for the purpose of search. In one example, memory can maintain a record indicating that an identifier of media content, profile information, and an address was received by a particular user device.

In another example, memory can maintain a record indicating that a particular user device provided information associated with another user device. These records can be useful data for statistical purposes and for provision to an advertiser. These records and/or profile information associated with users distributing or receiving distributed media content and/or advertisement content can be automatically communicated to an advertiser or other third party in exchange for compensation.

In another example of associating data, a record of received data can be maintained within memory 118 for relating received data to one another. Similarly, for example, a record of communicated data can be maintained for relating communicated data. Further, for example, if data is communicated in response to receipt of data, a record of the relationship of the received and communicated data may be maintained. The data may be stored in a table for associating the data with one another.

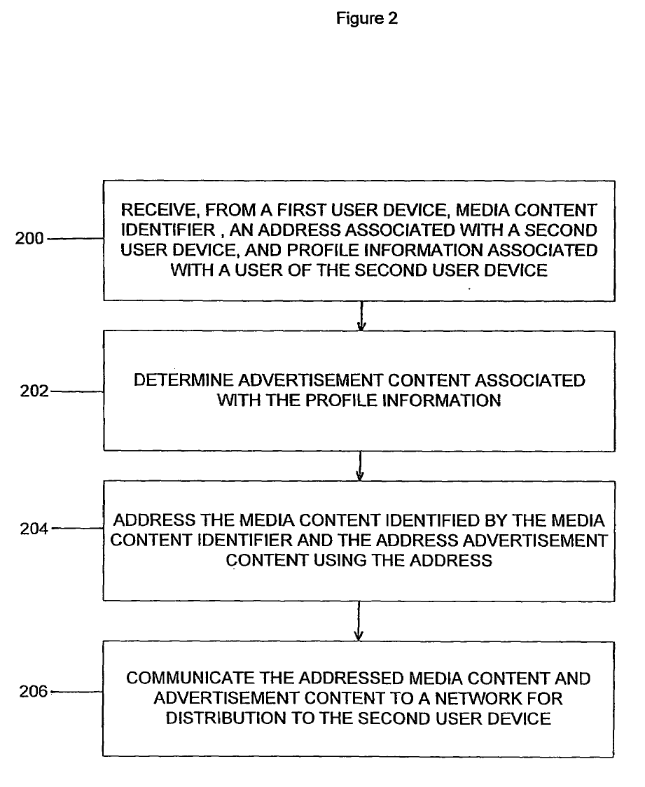

FIG. 2 is a flow chart illustrating an exemplary process for distributing media content and profile-based advertisement content to a user device in accordance with an embodiment of the subject matter disclosed herein. This exemplary process may be implemented by network system 100 shown in FIG. 1. In the example of FIG. 2, distributor 116 may implement the process alone or with another device or component of network system 100. Alternatively, any other device or component of network system 100 may alone or in combination implement the process.

Referring to FIGS. 1 and 2, distributor 116 may receive, from user device 104, a media content identifier, an address associated with user device 106, and profile information associated with a user of user device 106 (block 200). For example, user device 104 may communicate to distributor 116 the identification of a music MP3 file, an email address associated with user device 106, and profile information such as a name, gender, and age of a user associated with user device 106. The user of user device can select this data for communication to server 114 to implement distribution of the media content identified by the identifier to user device 106. An input module of server 114 can receive the data and route the data to distributor 116.

In block 202, distributor 116 determines advertisement content associated with the profile information received from user device 104. For example, memory 118 may store a table that associates profile information with advertisement content. Distributor 116 may search the table for advertisement content associated with the received profile information. For example, the received profile information may include gender and age of a user of a user device, and distributor 116 may search the table for advertisement content that is associated with the gender and age in the table.

In block 204, distributor 116 addresses media content identified by the media content identifier and the advertisement content using the address. For example, memory 118 can store a plurality of media content indexed by an identifier. Distributor 116 can search the plurality of media content using the media content identifier received from user device 104. Distributor 116 can retrieve media content identified by the media content identifier. Distributor 116 may use the address received from user device 104 to address the identified media content and the advertisement content in memory 118 found based on the profile information. In one example, the identified media content and the advertisement content can be stored in one or more messages that are addressed using the address. As a result of this step, the identified media content and the advertisement content can be addressed to user device 106 identified by user device 104.

In block 206, distributor 116 may communicate the addressed media content and advertisement content to network 102 for distribution to user device 106. For example, distributor 116 may manage and control an output module of server 114 to communicate the addressed media content and advertisement content to Internet 102 for distribution to user device 106. In one example, message(s) addressed with the address and containing the media and advertisement content can be communicated to user device 106 via the Internet 102.

The addressed media content and advertisement content may be contained in one or more messages suitable for communication over a network. The message(s) can be addressed to user device 106 and can carry the media content and the advertisement content. The network can receive the message(s) and route the message(s) to user device 106 for presentation to a user via user device 106. The user device can be operated to select that the media content be presented. Further, the advertisement content can be presented together with the media content.

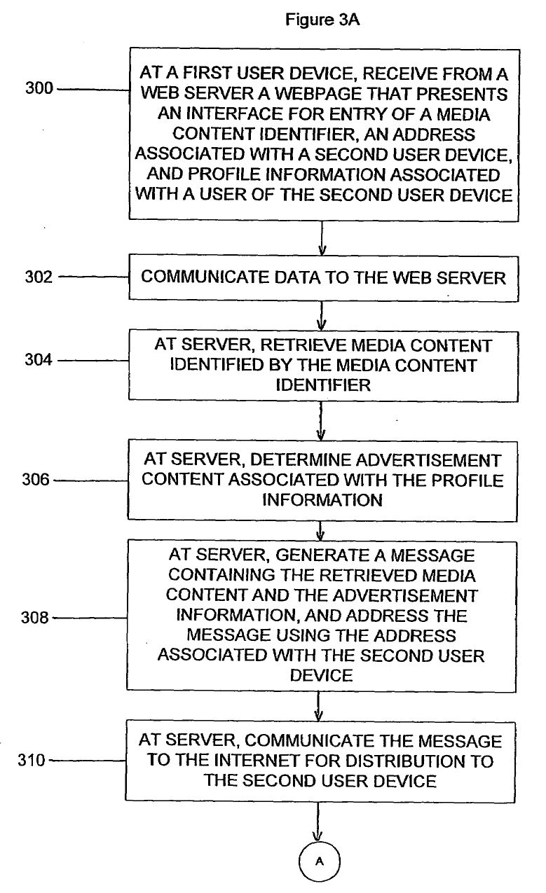

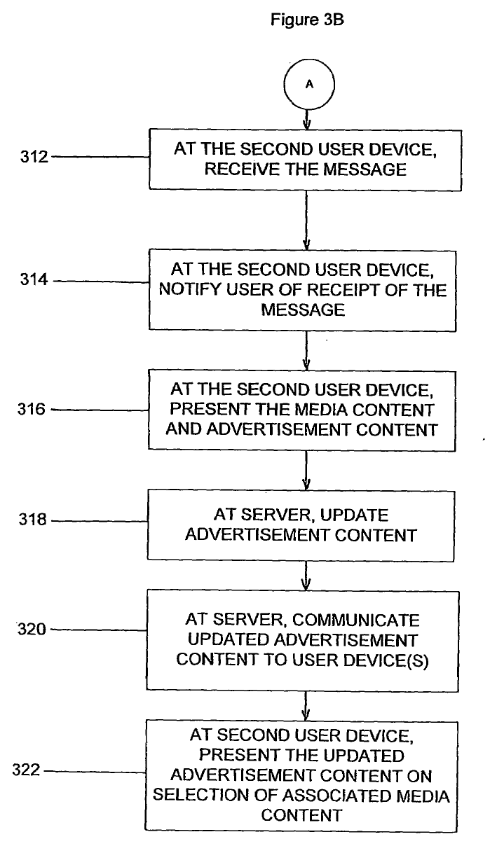

In one embodiment, media content and profile-based advertisement content can be distributed to a user device by request of a website user. The website can provide access to a web server of a media content provider. In this embodiment, the website user can communicate with the web server via the Internet for identifying media content, an address associated with a user device, and profile information associated with a user of the user device. The website server can receive the request, and manage the distribution of the identified media content and advertisement content associated with the communicated profile information to the user device in response to the request. FIG. 3 is a flow chart illustrating an exemplary process implementing this embodiment of the subject matter described herein. This exemplary process can be implemented by network system 100 shown in FIG. 1. In the example of FIG. 3, distributor 116 can implement the process. Alternatively, any other device or component of network system 100 may alone or in combination implement the process. Server 114 may be one or more web servers capable of communicating web pages to user devices and distributing media content to user devices. User devices 104 and 106 are capable of requesting and presenting web pages. The web pages can be in any suitable format such as HyperText Markup Language (HTML), Extensible HyperText Markup Language (XHTML), and the like.

Referring to FIGS. 1 and 3, user device 104 can receive from server 114 a web page that provides an interface for entry of a media content identifier, an address associated with user device 106, and profile information associated with a user of user device 106. For example, the web page can include text boxes, drop down menus, and the like for entry of the data. The user of user device 104 can enter data in the presented web page for requesting distribution of the identified media content to an identified user device 106. The user of user device 104 can also enter profile information of the user of the identified user device 106. The media content can be identified by entering text in a text box of a web page, and communicating the entered data to a web server associated with the web page. In this way, advertisement content relevant to the profile information, and thus the user of the identified user device 106, can be distributed to user device 106 along with media content identified by the user of user device 106.

Further, media content can be identified by selection using a user interface of user device 104 or during or after presentation of some or a portion of the media content to a user via user device 104. For example, the media content (such as a song, movie, or article) may be wholly or partially presented via user device 104 and the media content selected for distribution at this time. The media content may be communicated for presentation to user device 104 by server 114 via the Internet 102 or any other suitable technique. In one example, a web page can present the media content in a window and may also present an icon for sharing the media content to another user or user device. During or after presentation of the media content, the user can select a button on a web page associated with presentation of the media content to identify the media content for sharing with another user. Selection of the media content for share with another user may trigger text boxes, drop down menus, or the like for entry of an address associated with a user device of the other user, and profile information associated with the other user. On selection of the media content, user device 104 can associate the media content identifier for the presented media content for communication of the identifier to server 114.

After entry of the data on the web page, the user of user device 104 can use user interface 113 to communicate the data entered on the web page to server 114 (block 302). For example, the web page can include a button for use in selection by the user to communicate the data to server 114. The data communicated between a user device and a server can be using any suitable technique such as HTTP, a request/response standard for communicating data between a client and a server, or any other suitable technique or protocol for exchanging data. Server 114 can receive the data at an input/output module and forward the data to distributor 116 for processing.

In block 304, distributor 116 retrieves media content identified by the media content identifier. Distributor 116 or another component of server 114 can use the media content identifier to search memory 118 for media content identified by the media content identifier. For example, memory 118 may index media content by title of a song or movie, the artists associated with a song or movie, a date associated with specific media content, a producer of specific media content, or any other identifier suitable for identifying the entirety or a portion of the media content. The media content can be copied, formatted, encrypted, or compressed for communication to a user device via the Internet 102.

In block 306, distributor 116 determines advertisement content associated with the profile information contained in the data received from user device 104. Memory 118 can store a table that associates profile information with advertisement content. Distributor 116 can search the table for advertisement content associated with the profile information.

Table 1 below shows a database that associates profile information with advertisement content. The table can be used for associating profile information with advertisement content.

TABLE 1
Database Associating Profile Information with Advertisement
Content

| Profile Information | | |
|---|---|---|
| | Age Range | |
| Gender | (Years) | Advertisement Content |
| Male | 20-35 | Graphical Window for “CSI” |
| Female | 30-40 | Text and Graphical Window for “Legally Blonde” |
| | | movie DVD |

In the example of Table 1, profile information received from a user device may specify a 25-year old male. Table 1 specifies that a profile of a 20-35 year old male corresponds to an advertisement for the television show “CSI: Crime Scene Investigation”. Thus, a graphical window for this television show is associated with the profile of a 25-year old male specified by the user device. The graphical window may be content that is presentable to a user via a suitable user device. For example, a computer or smartphone running a WINDOWS® operating system (available from Microsoft Corporation of Redmond, Wash.) or WINDOWS MOBILE® operating system (available from Microsoft Corporation) can display a graphical window. As described in more detail below, such advertisement content can be communicated to a specified user device along with identified media content for presentation of both the advertisement content and the media content, either simultaneously or at different times, on the specified user device. The advertisement content is intended to be presented to a user (or operator) of the specified user device that matches the associated profile information. The advertisement content stored in the table can be an identifier for specifying the location of the advertisement content in a memory. For example, the advertisement content can be a pointer for identifying a location in memory of the media content.

Table 1 also specifies that a profile of a 30-40 year old female corresponds to a text and graphical window for a “Legally Blonde” movie DVD. The advertisement content can be data to display text and/or a graphical window for advertising the television show. Advertisement content for the show may be associated with this profile information because an advertiser believes that it is likely that a user matching this profile would be interested in the advertised DVD. The graphical window can be content that is presentable to a user via a suitable user device. The advertisement content can also include text. The text may be presentable to a user via a suitable user device, such as, for example, a handheld music player operable to present text (e.g., an APPLE IPOD NANO® handheld device, available from Apple Computer, Inc., of Cupertino, Calif.).

The communicated advertisement content can be content in more than one format (such as where text and a graphical window is provided) so that the advertisement content can be in a suitable format for presentation on a broader range of devices. For example, a handheld device may only be configured to present the text. Although, a computer can present text and a graphical window. Thus, more than one format can be provided such that the it is more likely that the advertisement content can be presented on the device receiving the content.

In another embodiment, a user can provide a media content identifier and an address associated with the user device, but not provide profile information. In this case, the user device, the server receiving the communication, or another device can provide the profile information. The profile information can be stored in one of the devices or components and associated with the address. In one example, the user device can have previously stored the profile information of a user of the user device associated with the address. In this example, the user device can automatically retrieve the previously stored profile information associated with the address, and send the profile information to the server along with the media content identifier and the address. In another example, the server can receive a media content identifier and an address, and can retrieve previously stored profile information associated with the address. The server or a device accessible by the server can store the profile information in memory for retrieval by use of the address. Accordingly, in this embodiment, the profile information can be retrieved by use of the address. Thus, in this embodiment, the profile information can be retrieved even if the user does not provide the profile information on request of distribution of the media content. The profile information can be stored on a social network server and associated with the address on the server. The server may therefore be accessed, for example, by another server or the user device directly to retrieve the profile information by use of the address.

In block 308, distributor 116 generates a message or a plurality of messages containing the retrieved media content and the advertisement content, and addresses the message using the address associated with the second user device. The message can be suitable for communication to a user device over the Internet 102. In one example, the address provided by user device 104 can be the IP address used by distributor 116 for addressing the message for delivery to user device 106. In this example, the message containing the retrieved media content and the advertisement content can be addressed with the IP address provided by user device 104.

In another example of addressing a message containing the retrieved media content and the advertisement content, the address provided by user device 104 can be used by distributor 116 to perform a lookup for an alias address for communicating the message to user device 104. Memory 118 or another memory, such as a memory remote from server 114, can contain a table containing addresses and alias addresses. For example, the address provided by user device 104 can be a user name serving as an address. In this example of the address being a user name, the user name can be used for looking up an alias IP address or another address for suitably addressing the message for delivery via the Internet or another network. In this example, the alias address can be used to address the message. The alias address can be used for communicating with user device 116 or another user device associated with the user.

In yet another example of addressing a message containing the retrieved media content and the advertisement content, a message addressed with the address provided by user device 104 or an alias address can be returned as undeliverable after the message has been communicated to the network for delivery. In this case, the alias address or another alias address can be found by lookup and used in place of the provided address. Alternatively, a notification message can be generated and communicated to user device 104 for notifying a user of user device 104 that the message was undeliverable. The user of user device 104 can be provided with an option of specifying another address, which can be communicated to distributor 116 for another attempt at delivering the message using the other specified address.

As referred to herein, the message can be any suitable message or messages for delivery of media content and advertisement content to a user device. For example, the message can be delivered as a plurality of packets that collectively contain the media content and advertisement content. In one example, the message can include an HTML document containing the media and advertisement content. In another example, the message can be an email message including the media and advertisement content as an attachment. Alternatively, the media content and advertisement content may be streamed to the user device for streaming presentation of the media content to the user.

In block 312, the message is received by user device 106. User device 106 can present notification of receipt of the message to the user (block 314). The user can select to accept or reject the message. For example, if the message is an HTML document, the user can select to open the HTML document with a web browser. In another example, if the message is an email message, the user can select to view the message with an email application (e.g., the MICROSOFT OUTLOOK® email application, available from Microsoft Corporation). Further, the user can select to present the media content via a suitable media content player, such as the WINDOWS MEDIA PLAYER™ application, available from Microsoft Corporation. The user can reject the message by deletion of the message from local storage 108 of user device 106.

The advertisement content can be tagged to the media content, encoded within the media content, or otherwise suitably integrated with the media content such that selection of the media content for presentation also presents the advertisement content. The advertisement content can be tagged to the beginning of a media content file, tagged to the end of a media content file, or contained within the media content. For example, the advertisement content can be contained within an ID3 tag, which can be tacked to the beginning or end of a media content file, such as an MP3 file. The advertisement content can be tagged using any other suitable technique or otherwise the advertisement content can be attached to the media content using any other suitable technique.

In one example of tagging media content with advertisement content, user device 106 can be a portable music player having a text display window and operable to play music in an MP3 format. In this example, the portable music player can download the media and advertisement content from a suitable Internet-connected computer. In this example, the media content is music in the MP3 format, and the advertisement content is text contained in an ID3 tag. The user of the portable music player can select to play the music. On play of the music, the advertisement content is displayed on the text display of the portable music player.

In another example of presentation of media and advertisement content, user device 106 can be a computer, such as a notebook computer, having a display and operable to play multimedia content, such as a high definition DVD format movie. In this example, the media content is a movie contained in an MPEG file, and the advertisement content is a graphical window for displaying an advertisement for a television show. The user of the computer can operate a user interface to select a play button for playing the movie. On play of the movie, the graphical window can be automatically presented in the same window as the movie or a different window as the movie. The advertisement window is presented in a portion of a display screen while the movie is presented in another portion of the display screen.

In one embodiment, user device 116 can include an application configured to automatically present the received advertisement content when the associated media content is presented. For example, the application can be configured to determine presentation of the media content via user interface 113, and in response to the determination, also control or otherwise implement the presentation of the advertisement content via user interface 113 either simultaneous with the media content or at a different time. The application can be communicated by server 114 to a user device when the advertisement content and media content is communicated. A portion of acceptance of the media content by a user of the user device can also include acceptance of the application by the user if the application is not already stored on the user device. The media content can be tagged with a trigger to activate the application to implement presentation of the advertisement content when the media content is triggered. In this way, the application stored on user device 116 can assure that advertisement content is presented to the user when the media content is presented.

In block 316, user device 116 presents the media content and advertisement content. The user of user device 116 can select the media content for presentation. As set forth above, the advertisement content can be integrated with the media content such that the advertisement content is also presented on presentation of the media content. Alternatively, as set forth above, an application can be triggered when the media content is presented, and in response to the triggering, the application can implement presentation of the advertisement content. The advertisement content and the media content can be simultaneously presented or presented at different times.

In block 318, distributor 116 updates advertisement content associated with the profile information contained in memory 118. Returning to the example of Table 1 described above, advertisement content associated with a profile of a 20-35 year old male can be changed from a graphical window for the television show “CSI” to a graphical window for the television show “The West Wing”. The advertisement content can be updated when a third party advertiser negotiates to associate different content with the particular profile such that the advertisement content can be presented to those matching that profile. Advertisement content for one or more profiles can be updated periodically.

In block 320, distributor 116 communicates the updated advertisement content to user devices that have previously received advertisement content for the associated profile information. Distributor 116 can automatically communicate the updated advertisement content. For example, a user device may have previously received media content and the advertisement content including the graphical window for the television show “CSI,” as provided in Table 1. When the advertisement content is updated with the graphical window for the television show “The West Wing,” as described in the above example, the updated advertisement content can be communicated to the user device via a network, such as the Internet 102. The message that communicates the updated advertisement content can include instruction or the user device can include instructions for replacing the previously received advertisement content (stored on the user device) with the updated advertisement content. In one example, an application can be communicated from the server to the user device for automatically updating the advertisement content when an update is received. The updated advertisement content can replace the previously-received advertisement content associated with the media content. Memory 118 can maintain a list of user device addresses associated with particular profiles such that the updated advertisement content is communicated to the user devices.

In block 322, user device 106 presents the updated advertisement content on selection of the associated media content. For example, when the user enters commands for presenting media content, updated advertisement content, if any, is presented either simultaneously with the media content or at the same time as the media content. In this way, advertisement content associated with media content stored on a user device can be updated with advertisement content. Thus, over time, third party advertisers can be enabled to provide updated advertisement content and negotiate to provide the updated advertisement content on a user device for a particular profile and/or associate the updated advertisement content with particular media content.

As described herein, a user of a first user device may desire to input commands to the first user device to implement communication of a media content identifier, an address associated with a second user device, and profile information to a server such that the identified media content is distributed to the second user device. In this way, the user of the first user device is willing to distribute media content because the user can share the media content with the user of the second user device without fee payment or with a small fee. The user can do so by providing the profile information of the intended recipient. The benefit to an owner of the identified media content is that an advertiser may provide advertisement content that is communicated to the second user device with the media content. The owner of the media content can be compensated by the advertiser in exchange for communicating the advertisement content to the second user device.

Further, in another embodiment similar to associating advertisement content with particular profile information as described above, advertisement content can be associated with particular media content such that when the media content is identified, then the associated advertisement content is communicated with the identified media content. Accordingly, a third party advertiser can associate advertisement content with particular media content.

Further, similar to updating advertisement content with profile information as described above, advertisement content can be updated and associated with particular media content. When there is an update, the updated advertisement content can be communicated to user device(s) that have previously received the media content. Memory 118 can maintain a list of user device addresses associated with particular media content such that the user devices can be communicated the updated advertisement content.

In one embodiment, media and advertisement content can be automatically distributed to a user device upon request of another user device to distribute the content. Alternatively, the user device intended for receipt of the content can be queried whether to receive the message or requested to provide further information or confirmation prior to receipt of all or a portion of the content. In this alternative, for example, user device 104 can request distribution of media content to user device 106 as described above. Distributor 116 can generate a message querying whether to distribute the content and communicate the message to user device 106. In response to receiving the message, the user of user device 106 can select to receive the content or select to decline distribution of the content. User device 106 can generate a message with the selection and communicate the message to the Internet 102 for transmission to distributor 116. If the message indicates a decline, distributor 116 can stop operations to distribute the content, and can communicate a notification message to user device 104 for indicating the decline. If the message indicates an acceptance, distributor 116 can continue operations to deliver the content, and can communicate a notification message to user device 104 for indicating the acceptance of the content.

In another embodiment, the media content and advertisement content can be requested by a user device after notification of the availability of the content. For example, user device 104 can request distribution of media content to user device 106 as described above. Distributor 116 can generate a message (such as an email message containing text explaining the availability of the content and a URL of the source) indicating the availability of the media content and a source of the availability of the content. The source can include server 114 or another suitable server for providing the media and advertisement content to user device 106. In one example, the source can be a web server, and the message can be an email message including a URL of the source. User device 106 can receive the email message, and the user of user device 106 can open the email message, and select the URL. User device 106 can present the web page corresponding to the URL. The web page can provide the user of user device 106 with information for obtaining the content by download. The user of user device 106 can interact with the web page and associated web pages for downloading the media and advertisement content.

In one embodiment, the user of a user device can be requested to confirm profile information and/or provide additional profile information prior to distribution of the media content to the user device. For example, user device 106 can receive a notification message indicating the availability of the media content to the user device via a URL. The user can control user device 106 to present the web page corresponding to the URL. The web page or an associated web page can include a request that the user confirm profile information and/or provide additional profile information prior to distribution of the media content to the user device. In an example of confirming profile information, the web page can present the profile information provided by user device 104 to the user of user device 106. In this example, the user of user device 106 can interact with the web page to either confirm or edit the profile information. In another example, the user of user device 106 can interact with the web page to provide additional profile information. After confirmation of the profile information and/or the provision of additional profile information, the media content and advertisement content may be distributed to the user device. The advertisement content can be changed or readjusted depending on any changes and/or additions made by the user of user device 106 to the profile information provided by the user of user device 104.

In one embodiment, users can be members of a social network, and media and advertisement content may be distributed to user devices via the social network. In one example, server 114 can be a server for the social network. A user can interact with web pages of the social network for selecting another user to distribute media content. The user can use the social network web pages to select media content identifier, an address associated with a second user device (e.g., a name of another user is selected and the address of the web page of the user is associated with the name such that the media can be delivered via a web page or email to the other user), and profile information associated with the user. The user can be notified of the availability of the media content on the user's personal social network web page when the user logs onto the web page or notified by an email message. The user can access the social network web pages for downloading the media content and the advertisement content.

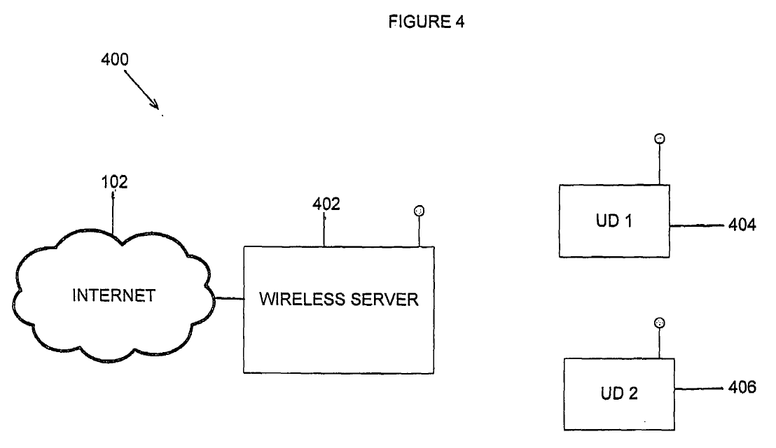

In yet another embodiment, media content and profile-based advertisement content can be distributed to a user device via a wireless network. A wireless network and a wireless server can be configured for distributing the media content and profile-based advertisement content to user devices in communication with the wireless network. In one example, the wireless network is a WLAN. FIG. 4 is a block diagram of a WLAN, generally designated 400, operable to distribute media content and profile-based advertisement content to one or more user devices in accordance with an embodiment of the subject matter disclosed herein.

Referring to FIG. 4, WLAN 400 can include a wireless server 402 configured to function as a wireless access point (WAP). The wireless network can adhere to the IEEE 802.11 standard or any other suitable wireless network standard. User devices 404 and 406 can be configured to wirelessly communicate with server 402. In one example, the wireless access point can provide wireless communication services to users operating user devices in a public setting such as a mall, a coffee shop, a restaurant, a city downtown, and the like.

Wireless server 402 can be configured to store media content or configured to access remotely stored media content via the Internet 102 or another network. The media content can be accessible by user devices 404 and 406 over the wireless network. In one example, wireless server 402 can be configured to broadcast media content (e.g., music, news information, and videos) to user devices 404 and 406 via the wireless network. A user device can be configured to receive the broadcast media content and present the media content via a user interface. In another example, wireless server 402 can communicate a media content menu to a user device. In this example, the user can operate the user device to select media content from the menu for communication by the server to the user device.

In one embodiment, a user of user device can be required to provide profile information of the user to server 402 prior to receipt of media content from the server. For example, user device 404 can access a web page or other suitable interface provided by server 402. The web page can provide an interface by which the user of user device 404 can enter profile information. Upon entry of the profile information and receipt of the profile information by server 402, server 402 can distribute or communicate media content to user device 404 via the wireless network. Further, as described herein, server 402 can distribute advertisement content to user device 404 based on the profile information.

In one embodiment, server 402 can communicate media content to a user device regardless of whether the user of the user device provides profile information. In this case, the media content is in a format that cannot be saved by the user device but only immediately presented by the user device to the user. A user desiring to save the media content can be required to provide profile information prior to receiving the media content in a storable format or receiving a license to save the media content.

In one example, server 402 can be operated by a commercial establishment such as a restaurant, a clothing store, a coffee shop, and the like to encourage users to visit the establishment. The server 402 can provide advertisement information containing information about the establishment, coupons, and the like. In this case, media content can be provided by the server to the user device in exchange for profile information of the user of the user device. The operator of the server can compensate an owner of the media content for the license to provide the media content to the user. The operator of the server can benefit because profile information of the user is obtained.

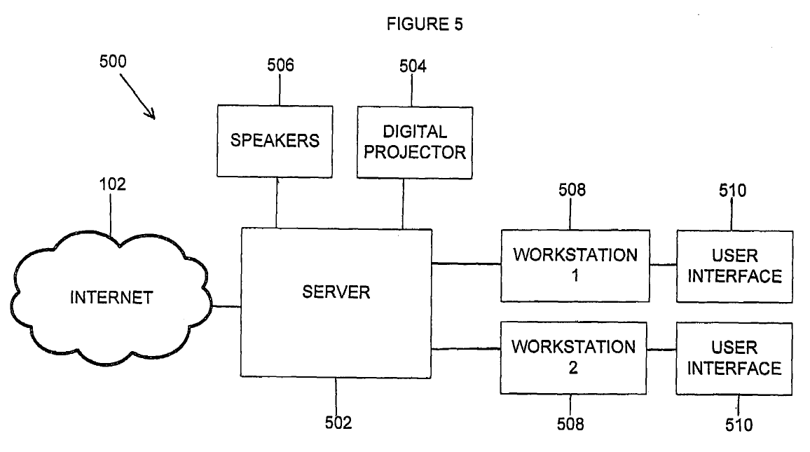

In another embodiment, media content and profile-based advertisement content can be distributed to a plurality of users based on a combination of the profiles of the users. In particular, media content for presentation to the users via one or more user devices can be identified. Profile information of the users can be received and can be collectively used for determining advertisement content for presentation to the users along with the media content. In one example, the media and advertisement content is presented to users in a movie theatre. FIG. 5 is a block diagram of a multi-user media content presentation system, generally designated 500, operable to present media content and advertisement content to a plurality of users in accordance with an embodiment of the subject matter described herein. In this example, system 500 is utilized for presenting media content and advertisement content to an audience in a movie theatre. Alternatively, system 500 can be utilized for presenting the content to a plurality of users in any environment where the users are being presented content from a single user device.

System 500 can include a server 502 configured to present media content to a plurality of users via a digital projector 504 and speakers 506. In particular, server 502 can be configured to store a digitized movie for presentation to a movie audience. Server 502 can be configured to receive the digitized movie via Internet 102. For example, system 500 can be operated by a theatre owner, and movies can be downloaded from the Internet 102 for presentation to an audience.

Server 502 can store advertisement content and profile information for some or all of the audience members. The advertisement content can include a plurality of different advertisements for presentation along with a movie based on the collective profile information of the audience members. In particular, server 502 can include a distributor configured to select one or more of the advertisements for presentation to the audience along with a movie based on the collective profile information of some or all of the audience members. Server 502 can control digital projector 504 and/or speakers 506 to present the selected advertisement(s) to the audience members along with the movie. For example, the advertisement(s) may include a product advertisement, a movie trailer, a TV advertisement, and the like.

In one example of selecting advertisements for presentation based on collective profile information, the distributor of server 502 can determine a collective profile of the audience members. The distributor can determine one or a plurality of characterizations of the audience members. In one example of a characterization of the audience members, the distributor can determine whether a majority of the audience is within a predetermined age range. Further, for example, the distributor can determine whether a majority of the audience is a predetermined gender, ethnicity, and/or the like. Based these profile characterizations of the audience, the distributor can select one or more advertisements for presentation based on collective profile of the audience.

The profile information of the audience members can be collected by any suitable technique. In one example, system 500 can include a plurality of workstations 508, which can be utilized for collecting profile information of the audience members. Workstations 508 can each include a user interface 510 with which profile information of the audience members can be entered or received. For example, user interface 510 can include a keyboard and/or mouse for use in entering the profile information and communicating the profile information to server 502. In another example, user interface 510 can be a credit card (or any other type of readable card containing personal information) reader configured to obtain profile information from some or all of the audience members. In this example, credit cards can be read and data obtained from the cards for determining profile information of the audience members. The data can be obtained when a credit card is used to purchase a ticket for the movie.

In another example, audience members can be asked for profile information in exchange for coupons or other incentives for providing the profile information. The audience member can enter the profile information using a user interface of a workstation or any other suitable user device. In one example, an operator of a ticket booth can ask an audience member for his/her profile information in exchange for coupons or other incentives. In this example, the ticket booth operator can enter the profile information in a workstation for communication to server 502.

The system of determining advertisement content based on collective profile information can be beneficial because advertisement content can be selected that is highly relevant to at least some or a majority of the audience members. This system can be advantageous because advertisers may be willing to pay a premium for advertisements if the advertisements are only presented to audience members having a collective profile that is relevant to the advertisement. In one scenario, an advertiser may only be required to pay each time an advertisement is presented. Thus, the advertiser may only be required to pay when the advertiser's advertisement is presented, which may only be when the collective profile of the audience meets a certain criteria.

In another embodiment, media and advertisement content can be streamed to a user device for streamed presentation to a user. The advertisement content can be streamed or broadcast to the user device after registration of the user with a media content provider. The advertisement content presented to the user can be based upon profile information provided by the user to the media content provider. The determination of the presented advertisement content can be based on the profile information in accordance with the subject matter described herein. In one example, the media content can be music and/or video streamed to the user device via the Internet. Further, advertisement content can be selected for presentation based on the streamed media content and/or the profile information of the receiving user. Advertisers can pay different rates for presentation of advertisement content based on profile information.

### Distribution of Profile-Based Advertisement Content Associated with Media Content

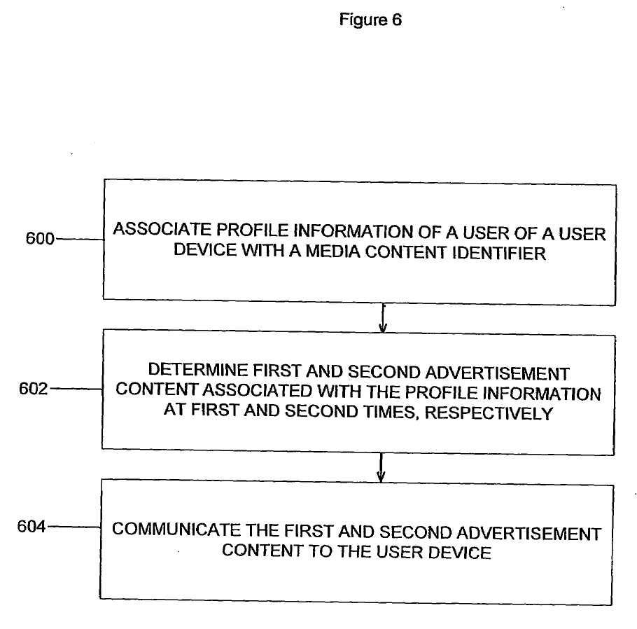

FIG. 6 is a flow chart illustrating an exemplary process for distributing profile-based advertisement content associated with media content according to an embodiment of the subject matter described herein. This exemplary process may be implemented by server 114 shown in FIG. 1. Referring to FIGS. 1 and 6, distributor 116 associates profile information of a user of a user device with a media content identifier (block 600). The media content identifier can identify media content that has been communicated to the user device. In one example of associating profile information of a user of a user device with a media content identifier, memory 118 may store a table that associates an address of a user device, profile information of a user of the user device, and a media content identifier.

In block 602, distributor 116 determines first and second advertisement content associated with the profile information at first and second times, respectively. In one example, different advertisement content can be associated with a particular profile at different times. A third party advertiser can negotiate to have different advertisement content associated with a profile.

In block 604, distributor 116 distributes the first and second advertisement content to the user device. The first and second advertisement content can be communicated to the user device at different times. For example, the first and second advertisement content can be communicated to the user devices at the times that the respective advertisement content are determined.

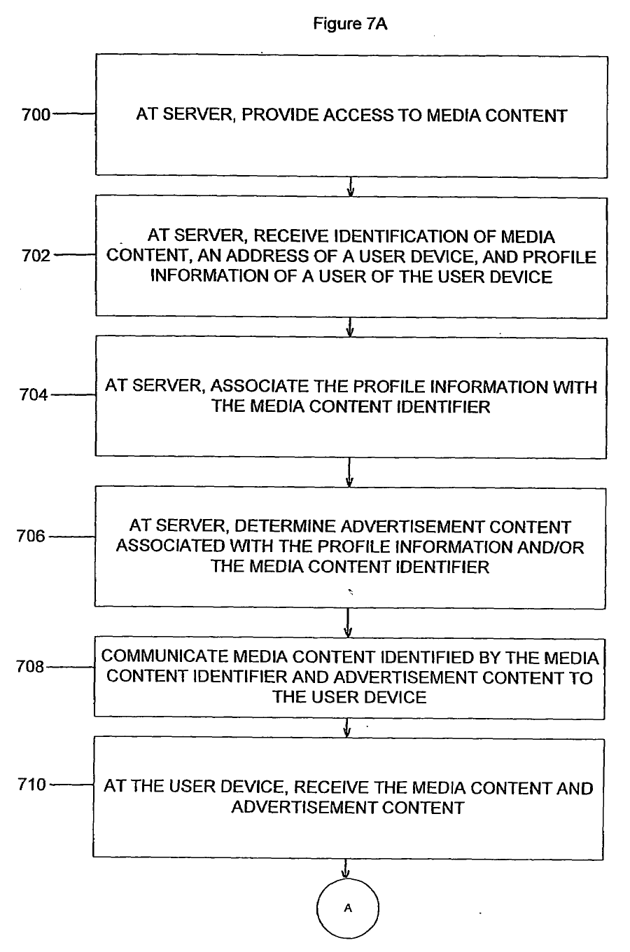

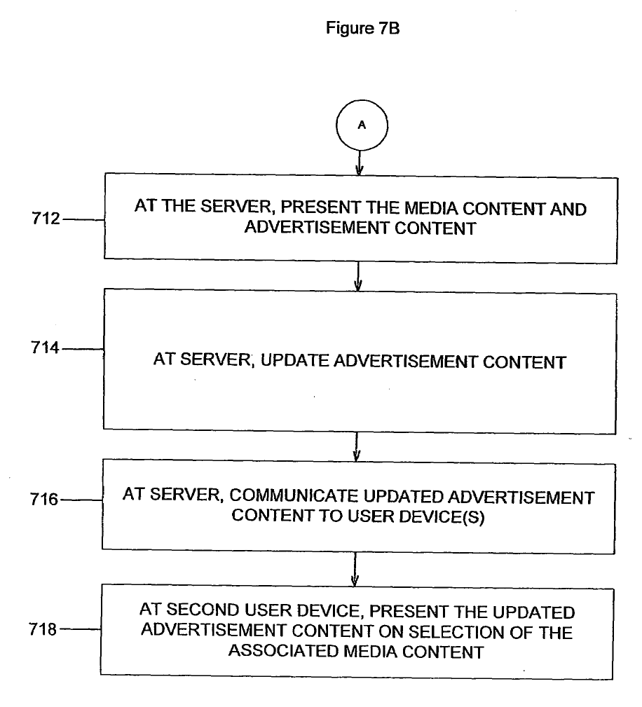

In one embodiment of distributing profile-based advertisement content associated with media content, a web server can provide on a website one or more media content for download by user devices. In this embodiment, a user device can access the website and request download of media content. The media content and advertisement content associated with the profile can be communicated to the user device. Further, user device can provide to the web server an address for communicating with the user device. The web server can store the address for use in communicating other advertisement content. FIG. 7 is a flow chart illustrating an exemplary process implementing this embodiment of the subject matter described herein. This exemplary process may be implemented by the system shown in FIG. 1.

In the example of FIG. 7, server 114 may be one or more web servers capable of communicating web pages to user devices and distributing media content to user devices. User device 104 is capable of requesting and presenting web pages. User device 106 is capable of requesting and presenting web pages and presenting media content. Referring to FIGS. 1 and 7, server 114 can provide access to media content via the Internet 102 (block 700). For example, server 114 can make media content accessible to user devices having access to the Internet 102. In this example, server 114 can provide a web page that identifies media content to user devices accessing the web page. The web page can be operable to interact with user devices such that a user of the user device can select media content for download and can provide profile information of the user and an address of the user device to server 114.

In block 702, server 114 receives identification of media content, an address of user device 106, and profile information of a user of user device 106. This data may be received from any suitable source. In one example, the data may be provided by user device 104 for sharing the identified media content with another user device, as described herein. In another example, the data may be provided by user device 106 for receipt of the identified media content by user device 106.

In block 704, distributor 116 associates the profile information with the media content identifier. In one example of associating profile information of a user of a user device with a media content identifier, memory 118 may store a table that associates the address of user device 106, profile information of the user of user device 106, and the media content identifier. Table 2 below shows a database that associates profile information of a user of the user device, an address of a user device and a media content identifier.

TABLE 2
Database Associating Profile Information, Media Content Identifier,
and Advertisement Content

| Profile | | | | |
|---|---|---|---|---|
| Information | | Media | | |
| | Age | Content | Advertisement | |
| Gender | (Years) | Identifier | Content | User Device Address |
| Male | 29 | Song | Graphical | User1@userdevice.com |
| | | “Walk | Window for | |
| | | This Way” | “CSI” | |
| | | by | | |
| | | Aerosmith | | |

In the example of Table 2, profile information received from a user device and stored in memory 118 specifies a 29-year old male. The media content identifier identifies the song “Walk This Way” by the band Aerosmith. The media content identifier can identify the location of a MP3 file of the song. The advertisement content is a graphical window for the television show “CSI”. The advertisement content stored in the table can be an identifier for specifying the location of the advertisement content in a memory. The user device to receive the media content and the advertisement content is identified by the email address User1@userdevice.com. The user device can be accessed by use of this email address.

In block 706, distributor 116 determines advertisement content associated with the profile information and/or the media content identifier. In the example of Table 2, the advertisement content determined in this step is entered into the Advertisement Content column. In one example, the advertisement content can be determined based on only the profile information. In this example, a third party advertiser can arrange or negotiate to provide particular advertisement content to users meeting a certain profile or demographic. In another example, the advertisement content can be determined based on only the media content identifier. In this example, a third party advertiser can arrange or negotiate to provide particular advertisement content to users receiving particular media content. In yet another example, a third party advertiser can arrange or negotiate to provide particular advertisement content to user meeting a certain profile or demographic and receiving particular media content.

In block 708, server 118 communicates to user device 106 the media content identified by the media content identifier and the advertisement content. User device 106 receives the media content and the advertisement content via the Internet 102 (block 710). Upon receipt of the media content and the advertisement content, user device 106 can notify the user of receipt via a user interface. The user can interact with the user interface for requesting presentation of the media content. In response to the request, user device 106 presents the media content and the advertisement content to the user via the user interface (block 712). As set forth above, the advertisement content may be integrated with the media content such that the advertisement content is also presented on presentation of the media content. Alternatively, as set forth above, an application can determine presentation of the media content, and present the advertisement content in response to determining the presentation of the media content. The advertisement content and the media content may be simultaneously presented or presented at different times.

In block 714, distributor 116 updates advertisement content associated with the profile information and/or media content identifier contained in memory 118. Returning to the example of Table 2, advertisement content associated with a profile of a 20-35 year old male and/or the media content identifier song “Walk This Way” by Aerosmith can be changed from a Graphical Window for the television show “CSI” to a Graphical Window for the television show “The West Wing”. The updating of the advertisement content can be dependent upon one or both of the profile information and the media content identifier.

The advertisement content may be updated when a third party advertiser negotiates to associate different content with the particular profile and/or the particular media content such that the advertisement content can be presented to those matching that profile and/or those that have received the media content. Advertisement content for one or more profiles can be updated periodically. In one example, the third party advertiser can negotiate to update the advertisement content for particular profile information. In this example, the advertisement content can be updated based on the profile information. In another example, the third party advertiser can negotiate to update the advertisement content for a particular media content identifier. In this example, the advertisement content can be updated based on the media content identifier. In yet another example, the third party advertiser can negotiate to update the advertisement content for particular profile information and particular media content identifier. In this example, the advertisement content can be updated based on the profile information and the media content identifier.

In block 716, distributor 116 communicates the updated advertisement content to user devices that have previously received advertisement content for the associated profile information and/or to user devices that have previously received the media content identifier. For example, a user device may have previously received media content and the advertisement content including the Graphical Window for the television show “CSI,” as provided in Table 2. When the advertisement content is updated with the Graphical Window for the television show “The West Wing,” as described in the above example, the updated advertisement content may be communicated to the user device via a network, such as the Internet 102. The message communicating the updated advertisement content may include instruction or the user device may include instructions for replacing the previously received advertisement content (stored on the user device) with the updated advertisement content. Memory 118 may maintain a list of user device addresses associated with particular profiles such that the user devices can be communicated the updated advertisement content.

In block 718, user device 106 presents the updated advertisement content on selection of the associated media content. For example, when the user enters commands for presenting media content, updated advertisement content, if any, is presented either simultaneously or at the same time as the media content.

### Distribution of User Identification-Tagged Media Content

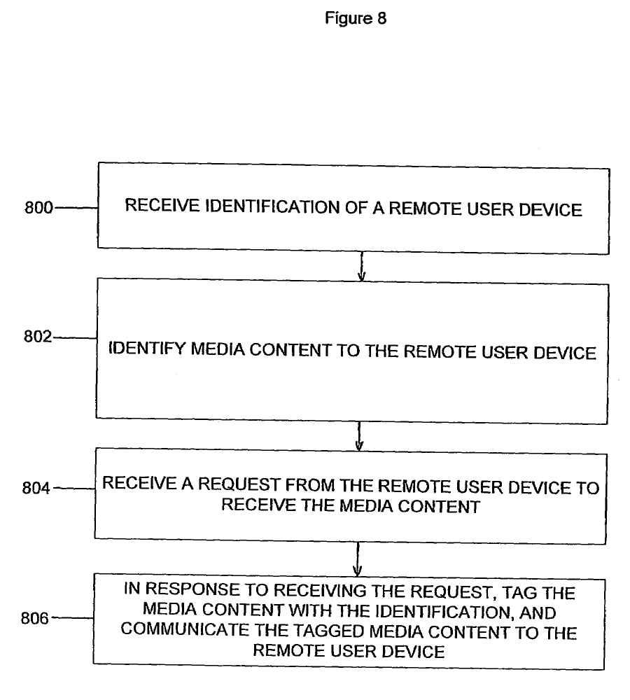

FIG. 8 is a flow chart illustrating an exemplary process for distributing user identification-tagged media content according to an embodiment of the subject matter described herein. This exemplary process may be implemented by server 114 shown in FIG. 1. Referring to FIGS. 1 and 8, distributor 116 receives identification of a remote user device (block 800). The identification of a remote user device can be an address, a user name of a user associated with the user device, or any other suitable identification of a user device. The identification can be received from the remote user device or any other device capable of communicating with server 114. For example, user device 104 or user device 106 can communicate an email address of user device 106 to server 114. Further, for example, the identification can be a social network user name that can be associated by a social network with a user device.

In block 802, distributor 116 identifies media content to the remote user device. Distributor 116 may provide a media content identifier (e.g., a song title or movie title) for presentation by server 114 to a user device. In one example, a web page identifying media content may be presented to user device 106 via the Internet 102. The web page may provide an interface for a user of user device 106 to select the identified media content and for the user to communicate the selection to server 114.

In block 804, distributor 116 receives a request from the remote user device to receive the media content. Continuing the above example provided in block 802, the user of user device 106 may enter commands into user device 106 to interact with the web page provided by server 114 for communicating identification of the selected media content to server 114. In this example, the user may enter the selection to request the downloading of a desired song or movie.

In block 806, distributor 116 tags the media content with the identification information, and communicates the tagged media content to the remote user device in response to receiving the request. Continuing the above example provided in blocks 802 and 804, distributor 116 can receive the identification of the selected media content via the Internet 102. Further, distributor 116 can retrieve the media content from memory and tag the media content with the identification information. Distributor 116 can communicate the tagged media content to the user device 106. As a result, user device 106 can receive the tagged media content for selective presentation by the user of the user device. Distribution of the media content by user device 106 can be monitored because the media content is tagged with the identification information of the user device. Unauthorized distribution of the media content can be traced back to the user device due to the tagging.

In one embodiment, a distributor can receive profile information and communicate advertisement content and media content to a user device based on the profile information as described herein. For example, distributor 116 can receive profile information associated with a remote user device. In this example, distributor 116 can determine advertisement content associated with the profile information. Distributor 116 can also communicate the advertisement content to the remote user device in response to receiving a request for media content. For example, the advertisement content can be communicated in response to receiving a request as described with respect to block 804.

Further, for example, advertisement content associated with the profile information can be determined at predetermined times. In response to receiving a request for media content, the advertisement content can be communicated to the remote user device. The determining of advertisement content can include determining first and second advertisement content at first and second times respectively. In this example, the first and second advertisement content can be communicated to the remote user device at first and second times, respectively.

### Filtering of Profile Content at a User Device

In one embodiment of the subject matter described herein, a user device can receive media content and a plurality of advertisement content that is filtered by the user device based on profile information. A server can distribute the media content and associated plurality of advertisement content to one or more user devices. A user device can store profile information and filter the advertisement content such that only advertisement content relevant to the stored profile information is presented along with the media content.

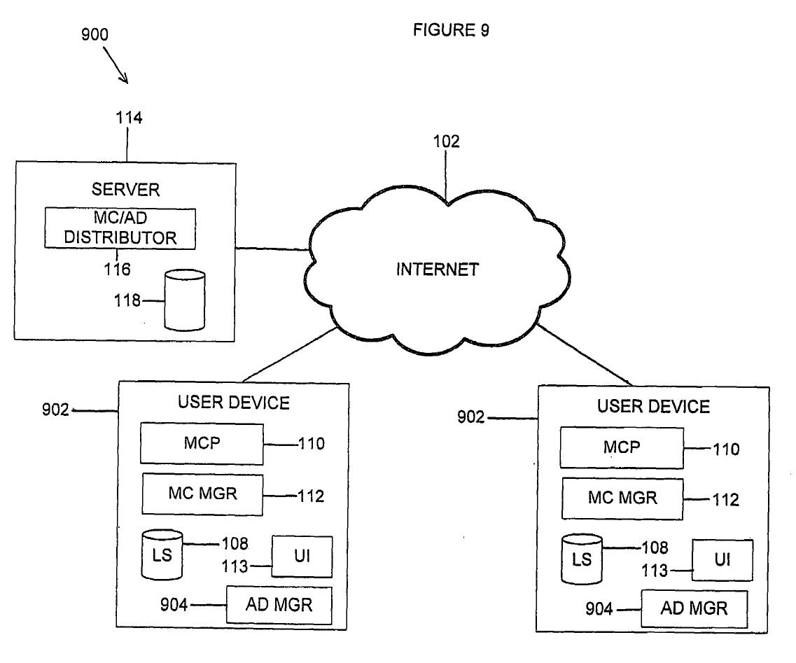

FIG. 9 is a block diagram of a network system, generally designated 900, operable to distribute media content and a plurality of advertisement content to a user device for filtering of the advertisement content at the user device based on profile information according to an embodiment of the subject matter described herein. Referring to FIG. 9, distributor 116 of server 114 can be configured to distribute media content and a plurality of advertisement content to user devices 902. In one example, the media content and advertisement content can be broadcast or streamed to one or more of user devices 902. In another example, the media content can be specifically requested by a user device, and the server can distributed the requested media content to the user device along with a plurality of advertisement content. Although only two user devices are shown in FIG. 9 for the purpose of clarity, system 900 can include many other user devices operable to interact with server 114 in accordance with the subject matter described herein.

Although system 900 is described in this example as including a server in communication with user devices via the Internet, any suitable network can be used for a server or other suitable distributor of data to one or more user devices. For example, a wireless or wired network can be utilized. In one example, the media content and advertisement content can be distributed using a suitable satellite-based communication service. This embodiment described herein can be beneficial to a satellite-based communication service, for example, because it is not necessary for a user device to provide profile information to a server of the media content. Rather, the user device stores profile information and filters a plurality of advertisement content based on the stored profile information.

Distributor 116 can be configured to distribute to a user device, media content along with a plurality of advertisement content associated with a plurality of profiles. In one example, the media content can be music. The advertisement content can include two text advertisements. One text advertisement can match the profile of a male in the age range of 50-65 years old. The other text advertisement can match the profile of a female in the age range of 35-40. The music and two text advertisements can be distributed to one or more user devices.

The distributed advertisement content can include a profile identifier or other suitable information for identifying the profile information corresponding to the advertisement content. Continuing the above example, the text advertisement matching the profile of a male in the age range of 50-65 years old can be distributed to one or more user devices along with a profile identifier for indicating that the text advertisement is associated with the profile of a 50-65 year old male. Similarly, continuing the above example, the text advertisement matching the profile of a female in the age range of 3540 year old can be distributed to one or more user devices along with a profile identifier for indicating that the text advertisement is associated with the profile of a 35-40 year old female. Although this example describes the use of text advertisements, any other type of advertisement content as described herein and any combination of types of advertisement content can be associated with media content for distribution to one or more user devices.

User devices 902 can be configured to receive the media content and plurality of advertisement content. The content can be received by user devices 902, and can be stored in local storage 108 of a respective user device. The user device can be configured to receive the content by one or more techniques as described herein.

User device 902 can include an advertisement content manager 904 configured to compare profile identifiers associated with received advertisement content to profile information stored at user device 902. Advertisement content manager 904 can determine which profile identifier matches the stored profile information. Continuing the above example, the stored profile information may be for a 37 year old female. In this example, the profile identifier for a 3540 year old female matches the stored profile information. In another example, a 62 year old male would match a profile identifier for a 50-65 year old male.

Advertisement content manager 904 can “filter in” or store the advertisement content corresponding to the profile identifier that matches the stored profile information. The “filtered in” advertisement content can be presented along with the media content in accordance with the subject matter described herein. For example, the “filtered in” advertisement content can be presented with the media content on selection of the media content by the user of the user device for presentation. If the media content is streamed in, the “filtered in” advertisement content can be presented when the media content is presented by the user device.

The received advertisement content associated with a profile identifier that does not match the stored profile information can be prevented from presentation along with the media content. This received advertisement content can be referred to as “filtered out” advertisement content. Advertisement content manager 904 can prevent the “filtered out” advertisement content from being presented along with the media content.

On presentation of the “filtered in” advertisement content, advertisement content manager 904 can generate and communicate to server 114 a message indicating that the advertisement content has been presented. The message can identify the advertisement content, an advertiser associated with the advertisement content, a time of presentation, the media content presented with the advertisement content, the profile identifier associated with the advertisement content, and/or profile information stored in the user device. The data contained in the message can be beneficial feedback to the operator of server 114 for statistical purposes. Further, the data can be beneficial to an advertiser for statistical purposes. The data can also be used by the server operator for billing an advertiser at some rate at which the advertisement content has been presented on a user device and/or for filling an advertiser at some rate at which the advertisement has been downloaded to a user device having matching profile information.

The embodiment described above of filtering advertisement content based on profile information can be beneficial to advertisers because the advertisement content is targeted to particular users. In particular, the advertisement content is associated with particular profiles. A plurality of advertisement content for a plurality of advertisers can be communicated along with media content. The different advertisement content can correspond to different profiles. The advertisement content corresponding to a profile of a user of a receiving user device can be “filtered in” for presentation along with the media content. The other advertisement content that does not correspond to a profile of a user of the receiving user device can be “filtered out” such that the advertisement content is not presented along with the media content. Thus, the advertisement content can be targeted by advertisers to only users that may be interested in the advertisement.

### Negotiating and Contracting Between a Media Content Provider and an Advertiser

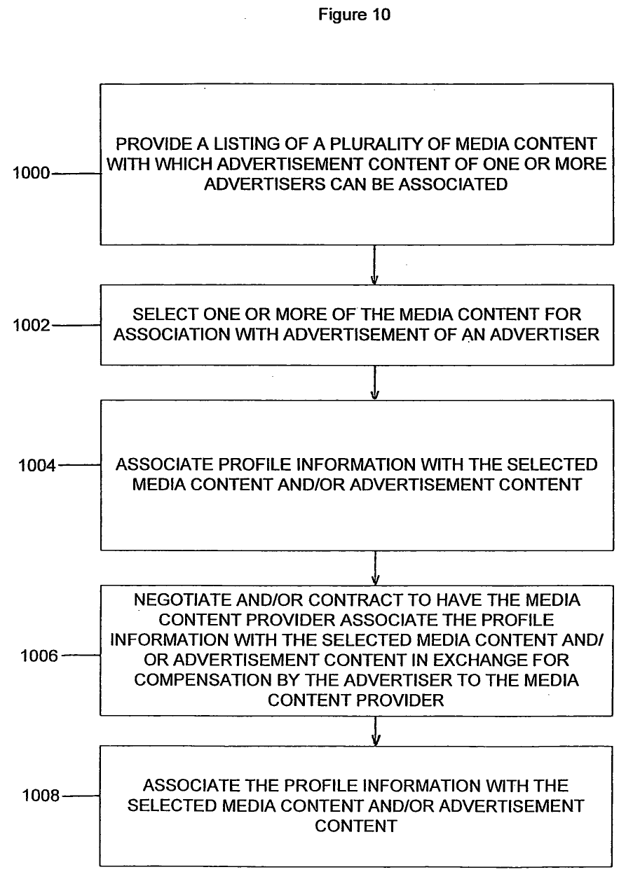

In another embodiment of the subject matter described herein, a process is provided for negotiating and contracting between a media content provider and an advertiser for associating advertisement content for the advertiser with media content. FIG. 10 is a flow chart illustrating an exemplary process for negotiating and contracting between a media content provider and an advertiser for distributing media and advertisement content in accordance with the subject matter described herein. Referring to FIG. 10, a media content provider can present a listing of a plurality of media content with which advertisement content of one or more advertisers can be associated (block 1000). For example, the presented listing of media content can include an identification of music and/or movies. The listing can be provided on a website, provided orally to an advertiser, provided in a paper document, and/or electronically communicated to an advertiser.

In block 1002, one or more of the media content in the listing can be selected for association with advertisement content of an advertiser. The selection can be made by the advertiser. For example, the advertiser can select the media content on a website of the media content provider by using a web browser. Alternatively, the selection can be made orally, by indication on a paper document, and/or electronically communicated to the media content provider.

In block 1004, profile information can be associated with the selected media content and/or advertisement content. The advertiser can associate the profile information with the selected media content and/or advertisement content. The profile information can match profiles of users that the advertiser deems will be interested in the advertisement content and/or media content. As described herein, the advertisement content can be presented to users having a profile matching the profile information. Thus, the advertiser can be expected to desire to have advertisement content presented to users with particular profiles.

In block 1006, the media content provider and advertiser can negotiate and/or contract to have the media content provider associate the profile information with the selected media content and/or advertisement content in exchange for compensation by the advertiser to the media content provider. The advertiser can agree to pay the media content for associating the profile information with the selected media content and/or advertisement content in accordance with the subject matter described herein. For example, the advertiser can agree to pay the media content provider each time that the advertisement content is downloaded to a user device associated with a user having a matching profile. In another example, the advertiser can agree to pay the media content provider each time that the advertisement content is presented to a user having a matching profile.

In block 1008, the media content provider can associate the profile information with the selected media content and/or advertisement content. This association can be performed after agreement or contracting by the media content provider and the advertiser in accordance with the terms negotiated in block 1006. The association of the profile information with the selected media content and/or advertisement content can be in accordance with the subject matter described herein. The media and advertisement content can be distributed in accordance with the subject matter described herein.

It will be understood that various details of the subject matter disclosed herein may be changed without departing from the scope of the disclosed subject matter. Furthermore, the foregoing description is for the purpose of illustration only, and not for the purpose of limitation, as the subject matter disclosed herein is defined by the claims as set forth hereinafter.

What is claimed is:

1. A method of distributing media content and profile-based advertisement content to a user device, the method comprising:
receiving, from a first user device, media content identifier, an address associated with a second user device, and profile information associated with a user of the second user device;
determining advertisement content associated with the profile information;
addressing the identified media content and the advertisement content using the address; and
communicating the addressed media content and the advertisement content to a network for distribution to the second user device.

2. The method of claim 1 wherein determining advertisement content comprises determining first and second advertisement content associated with the profile information at first and second times, respectively, and wherein communicating the advertisement content comprises communicating the first and second advertisement content to the second user device.

3. The method of claim 2 wherein communicating the first and second advertisement content includes communicating the first and second advertisement content to the second user device at the first and second times, respectively.

4. The method of claim 1 comprising presenting the advertisement content and the media content on the second user device.

5. The method of claim 4 wherein presenting the advertisement content comprises simultaneously presenting the advertisement content and the media content.

6. A method of distributing profile-based advertisement content associated with media content, the method comprising:
associating profile information of a user of a user device with a media content identifier;
determining first and second advertisement content associated with the profile information at first and second times, respectively; and
communicating the first and second advertisement content to the user device.

7. The method of claim 6 wherein communicating the first and second advertisement content comprises communicating the first and second advertisement content at the first and second times, respectively.

8. The method of claim 6 comprising, at the user device:
receiving a user request to present media content associated with the media content identifier; and
in response to receiving the user request, presenting the media content and at least one of the first and second advertisement content.

9. The method of claim 6 wherein associating profile information comprises associating profile information of users of first and second user devices with the media content identifier, and wherein communicating the first and second advertisement content comprises communicating the first and second advertisement content to the first and second user devices, respectively.

10. The method of claim 6 wherein the user device is a first user device, and the method comprising receiving from a second user device identification of the profile information and the media content.

11. The method of claim 6 comprising negotiating contract terms with an advertiser associated with the advertisement content to associate the profile information with the media content identifier.

12. The method of claim 11 wherein negotiating the contract terms comprises determining a predetermined time period during which the advertisement content of the advertiser is associated with the profile information.

13. The method of claim 11 wherein at least one of the first and second times is during the predetermined time period, and wherein the method comprises, at the user device:
receiving user request to present media content associated with the media content identifier during the predetermined time period; and
in response to receiving the user request during the predetermined time period, presenting the media content and the advertisement content of the advertiser.

14. The method of claim 6 wherein communicating the first and second advertisement content comprises communicating the first and second advertisement content via a satellite-based network.

15. The method of claim 6 comprising:
receiving profile information and address information of the user device;
receiving, from the user device, a request to receive the media content; and
in response to receiving the request, communicating the media content and at least one of the first and second advertisement content to the user device.

16. A method of distributing user identification-tagged media content, the method comprising:
receiving identification information of a remote user device;
identifying media content to the remote user device;
receiving a request from the remote user device to receive the media content; and
in response to receiving the request, tagging the media content with the identification information and communicating the tagged media content to the remote user device.

17. The method of claim 16 comprising:
receiving profile information associated with the remote user device;
determining advertisement content associated with the profile information; and
in response to receiving the request, communicating the advertisement content to the remote user device.

18. The method of claim 16 comprising:
receiving profile information associated with the remote user device;
at predetermined times, determining advertisement content associated with the profile information;
in response to receiving the request, communicating the advertisement content to the remote user device.

19. The method of claim 18 wherein determining advertisement content comprises determining first and second advertisement content at first and second times, respectively, and wherein communicating the advertisement content comprises communicating the first and second advertisement content to the remote user device.

20. The method of claim 19 wherein the first and second advertisement content are communicated at first and second times, respectively.
